(19) United States
(12) Patent Application Publication
(10) Pub. No.: US 2014/0136281 A1
(43) Pub. Date: May 15, 2014

(54) METHOD AND SYSTEM FOR CREATING A NATURAL GAS OR OTHER ALTERNATE FUEL REFUELING STATION NETWORK

(71) Applicant: Lightening Energy, Dover, NJ (US)

(72) Inventors: Duncan Culver, Howell, NJ (US); Michael L. Epstein, Bedminster, NJ (US); Christopher K. Dyer, Madison, NJ (US)

(21) Appl. No.: 14/076,866

(22) Filed: Nov. 11, 2013

Related U.S. Application Data
(60) Provisional application No. 61/726,787, filed on Nov. 15, 2012.

(51) Int. Cl. G06Q 50/06; G06Q 30/02

(52) U.S. Cl. CPC G06Q 50/06; G06Q 30/0202
USPC 705/7.31

(57) ABSTRACT

A method for creating an alternate fuel vehicle refueling network includes receiving first location data and first alternate fuel refueling station interest data from a first remote device; receiving second location data and second alternate fuel refueling station interest data from a second remote device; and using the first location data, first alternate fuel refueling station interest data, second location data and second alternate fuel refueling station interest data to permit creation of a first alternate fuel refueling station.

This claims the benefits of Provisional Patent Application U.S. 61/726,787 filed on Nov. 15, 2013 and hereby incorporated by reference herein.

### BACKGROUND

Compressed natural gas (CNG) or liquid natural gas (LNG) vehicles are already in use, and liquid propane vehicles are also known. Natural gas vehicles are typically used in bus fleets or areas where compressed or liquid natural gas fueling stations are operated by a central operator. Honda now offers natural gas vehicles and they are in wide use worldwide. The term alternate fuel as used herein refers to CNG, LNG propane, primarily ethanol and all non-gasoline and diesel fueling stations.

### SUMMARY OF THE INVENTION

The present invention provides a method for creating an alternate fuel refueling station network comprising:
receiving first location data and first alternate fuel refueling station interest data from a first remote device;
receiving second location data and second alternate fuel refueling station interest data from a second remote device;
using the first location data, first alternate fuel refueling station interest data, second location data and second alternate fuel refueling station interest data to permit creation of a first alternate fuel refueling station.

The present invention also provides a method for creating an alternate fuel refueling station network comprising:
receiving first location data from a first remote device;
providing possible location data for a first alternate fuel refueling station as a function of the first location data;
receiving first interest data from the first remote device in the first alternate fuel refueling station; and
providing the first interest data to a second remote device to generate further interest data in the first alternate fuel refueling station.

The present invention also provides a method for creating an alternate fuel refueling station network comprising:
receiving first location data from a first remote device;
providing alternate fuel refueling station data to the first remote device as a function of the first location data;
in response to the alternate fuel refueling station data, receiving data from the first remote device indicating interest in creating a first alternate fuel refueling station so as to define first interest data;
providing the first interest data to a second remote device; and
in response to the first interest data, receiving second location data including actual location data for a first alternate fuel refueling station.

The present invention also provides a computerized system for creating an alternate fuel refueling station network comprising:
a server;
a plurality of remote devices capable of communicating with the server, including a first remote device and a second remote device;
the server including first location data from the first remote device, alternate fuel refueling station data, second location data from the second remote device, interest data from the first and second remote devices, and first alternate fuel refueling station data, the first alternate fuel refueling station data being a function of the interest data.

The present invention also provides a computerized system for creating an alternate fuel refueling station network comprising:
a server;
a plurality of remote devices capable of communicating with the server, including a first remote device and a second remote device;
the server including first location data from the first remote device, possible location data for a first alternate fuel refueling station as a function of the first location data, first interest data from the first remote device in the first alternate fuel refueling station, and further interest data from the second remote device in the first alternate fuel refueling station.

The present invention also provides a computerized system for creating an alternate fuel refueling station network comprising:
a server;
a plurality of remote devices capable of communicating with the server, including a first remote device and a second remote device;
the server including first location data from the first remote device, first interest data from the first remote device, second location data from the second remote device as a function of the first interest data, the second location data including actual location data for a first alternate fuel refueling station.

The present invention also provides an alternate fuel refueling station network created by one of the above methods or systems.

### BRIEF DESCRIPTION OF THE DRAWINGS

One embodiment of the method and system of the present invention may be further described using the following drawings, in which:

FIG. 1 shows a first GUI of a first remote device with a web page for receiving first location data;

FIG. 2 shows the first GUI of the first remote device with a web page providing data on various existing and possible alternate fuel vehicle refueling stations;

FIG. 3 shows the first GUI of the first remote device with data concerning possible refueling station 104 of FIG. 2;

FIG. 4 shows the first GUI of the first remote device with data concerning possible refueling station 106 of FIG. 2;

FIG. 5 shows the first GUI of the first remote device with a web page permitting input of data concerning possible participation in creating refueling station 106 of FIG. 2;

FIG. 6 shows a second GUI of a second remote device with data concerning the possible refueling station 120 of FIG. 2;

FIG. 7 shows the second GUI of the second remote device with a web page permitting input of data concerning possible participation in creating refueling station 120 of FIG. 2;

FIG. 8 shows a third GUI of a third remote device with data concerning the possible refueling station 130 of FIG. 2;

FIG. 9 shows the third GUI of the third remote device with a web page permitting input of data concerning possible participation in creating refueling station 130 of FIGS. 2; and

FIG. 10 shows a schematic overview of one embodiment of the system of the present invention.

### DETAILED DESCRIPTION OF THE PREFERRED EMBODIMENT

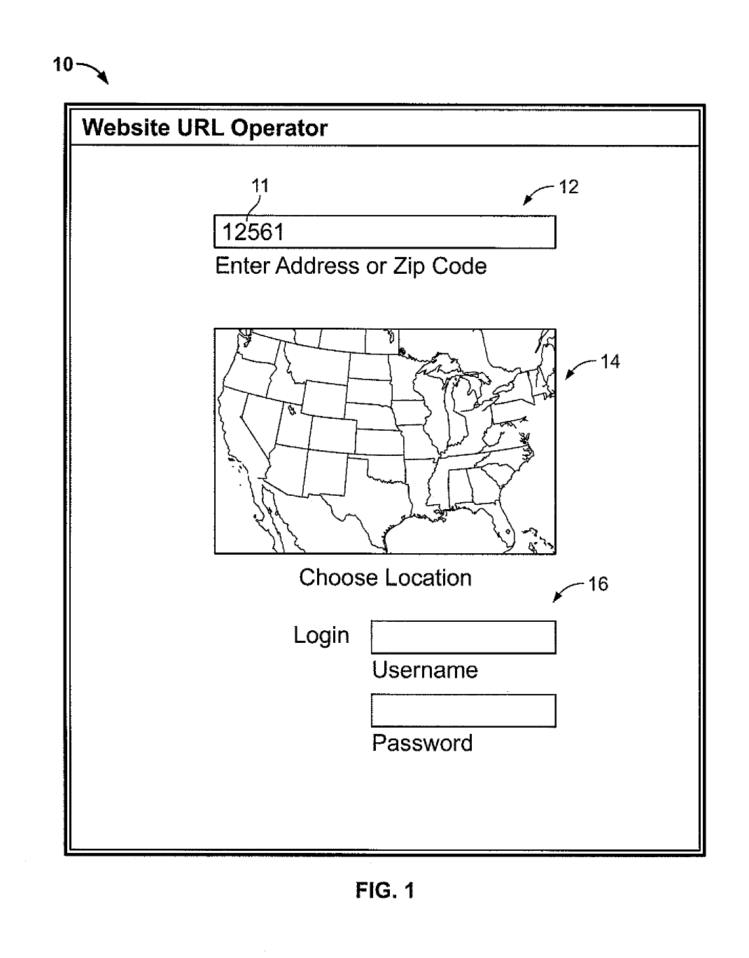

FIG. 1 shows a first graphical user interface (GUI) of a first remote device with a web page 10 for receiving first location data 11. The first remote device may be any device capable of interacting as a client with a server, for example a home computer, cell phone with web capabilities, or tablet, connected for example via a TCP/IP protocol to a server. The first remote device may have voice capabilities as well for providing or receiving any of the information herein.

Web page 10 permits a user of the first remote device to enter first location data 11, for example via an address or zip code field 12, a map 14 permitting receipt of for example a mouse pointer information, or via a log-in field 16 where the users location information is already known, for example via a database.

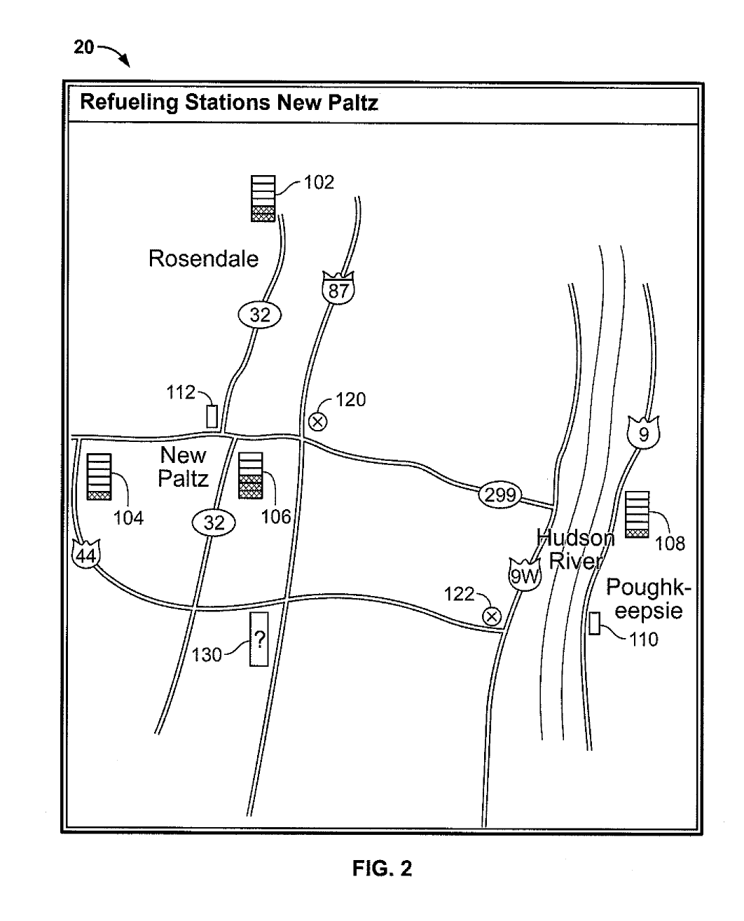

The first location data 11, here a zip code, can be received at a server providing web page 10, and in response to the first location data 11 the server can provide data concerning an existing or envisioned network of alternate fuel refueling stations via for example a web page 20, as shown in FIG. 2.

The data in FIG. 2 may include a map indicating for example completed alternate fuel refueling stations 110, 112, possible alternate fuel refueling stations 102, 104, 106, 108 with interest data including payment data and actual location data concerning the stations already received and stored by the server, possible alternate fuel refueling stations 120, 122 with actual location data concerning the stations stored by the server, but no payment data yet received, and possible alternate fuel vehicle refueling station 130 with interest data but not actual location data yet received.

FIG. 2 thus represents an overview of an existing and possible alternate fuel vehicle refueling network in which members of a social network or simply those accessing a website may be provided not only with information regarding existing alternate fuel refueling stations 110, 112 in the network, but also in one embodiment on becoming participants in building up the network, for example by investing and providing payment data for shares in possible alternate fuel refueling stations 102, 104, 106 and 108.

In yet further embodiments of the present invention the method and system of the present invention permit landowners and others to provide actual location data, for example so that possible alternate fuel stations 120, 122 are created, and in yet another embodiment for users simply to express certain partial interest in creating an alternate fuel refueling station 130 in a certain general location.

An entire alternate fuel vehicle refueling station network thus can be created from the bottom up based on actual needs and desires of the participants of the network.

The creation of the network will now be described in greater detail.

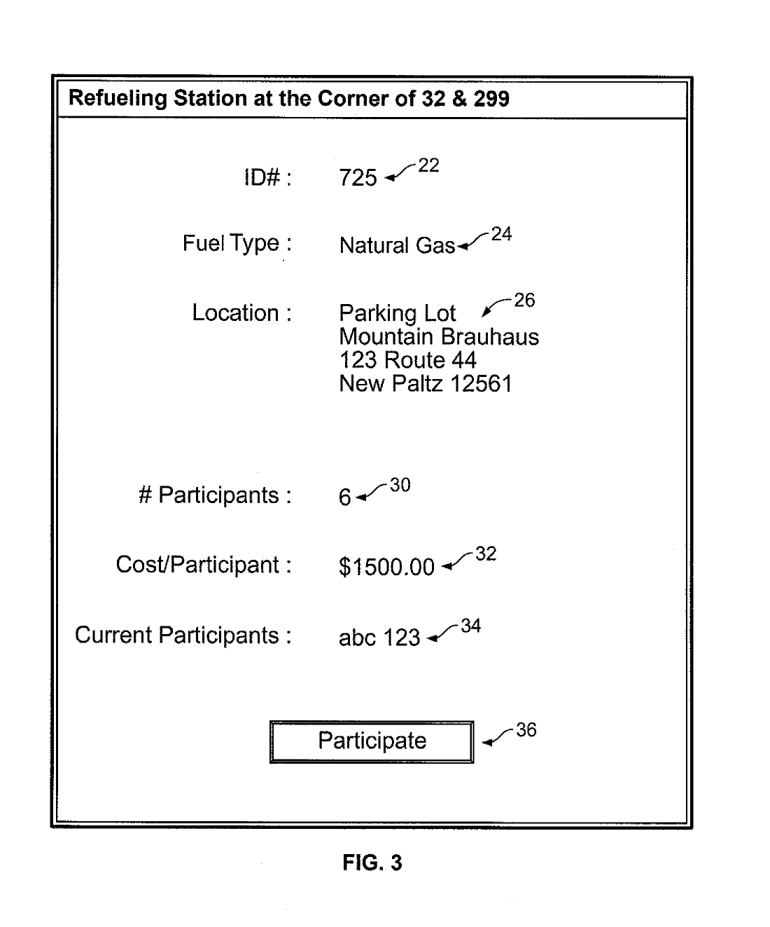

FIG. 3 shows the first GUI of the first remote device with data concerning possible refueling station 104 of FIG. 2. Upon for example, clicking by a user of the first remote device on the graphical representation of refueling station 104, current data on the possible refueling station 104 can be provided to the first remote device. The alternate fuel vehicle refueling station data may include network ID data 22, alternate fuel type data 24, location data 26, participant number data 30, cost data 32, current participant data 34 and a participate button 36.

For this possible station 104, solely one participant has provided payment data, and if the system is so designed, access to the participant, for example via email contact may be provided. In a preferred embodiment, access to the participant is only provided if the user of the first remote device and the participant are members of a social network, for example the social network running the server.

FIG. 3 thus provides the first remote device with data including actual location data and participant data, the participant having already provided interest and payment data to the server. The user of the first remote device thus can be assured that submission of payment data by a certain number of participants, here a total of six participants, will result in creation of the alternate fuel vehicle refueling station. For example, the operator of the website will create all legal documents and purchasing and then forward legal conformation of the participation of the user in the alternate fuel refueling station 104. The legal form may vary from state to state or location to location, but may be for example a partnership, time-share, LLC, other contractual relationship or other legal form. In other embodiments, payment may be delayed until later for example after formation of the alternate fuel refueling station.

The location, cost and other data may have been provided by a lead participant, by the network running the server, by the location owner, a third party or any combination.

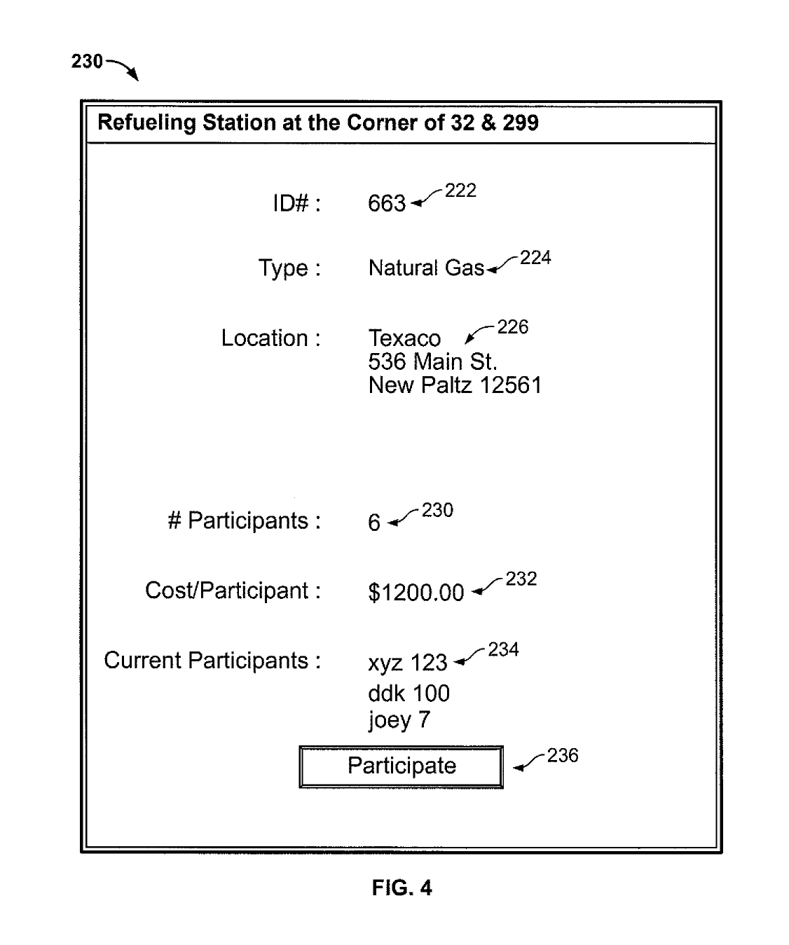

FIG. 4 shows the first GUI of the first remote device with data 230 concerning possible refueling station 106 of FIG. 2. The alternate fuel vehicle refueling station data 230 may include network ID data 222, alternate fuel type data 224, location data 226, participant number data 230, cost data 232, current participant data 234 and a participate button 236. Here, three participants xyz123, ddk100 and joey 7 have provided payment already.

Map 20 in FIG. 2 can be updated with visual clues expressing actual participants, for example six bars on location 106 can be shown, with three filled, and one more filled as a further participant joins.

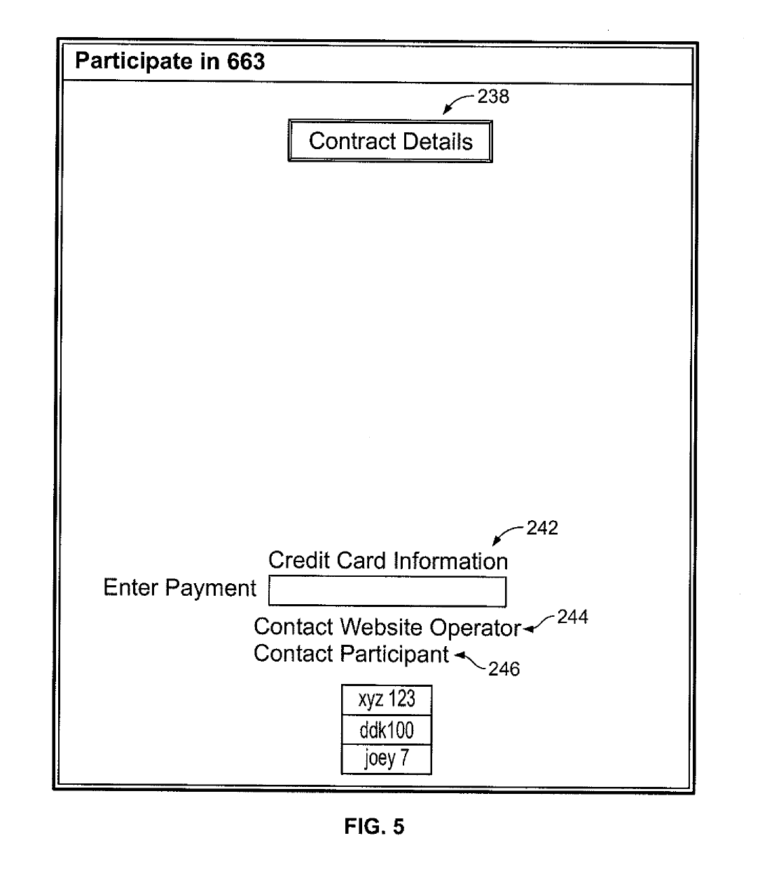

FIG. 5 shows the first GUI of the first remote device with a web page which may result upon clicking of the participate button 236. This web page permits input of data concerning possible participation in creating refueling station 106 of FIG. 2, and also provides for example for the user to receive contract details, for example via a button 238. Any legal documents to be signed or already signed, including for example land lease information and the basis for the cost information may be provided. These details advantageously also may be solely available to members of the social network mentioned above.

Payment information can be received for example via input 242, and may be cleared for example by the server and operator of the server.

The server operator can also be contacted via input 244, and other participants via input 246 for example.

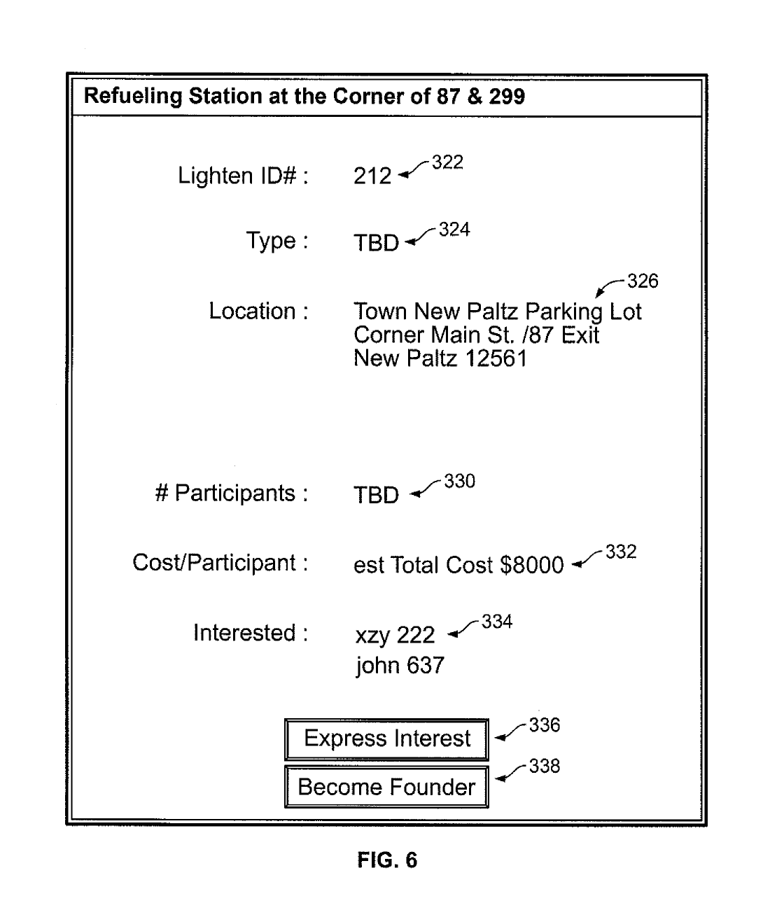

FIG. 6 shows a second GUI of a second remote device with data concerning the possible refueling station 120 of FIG. 2. The alternate fuel vehicle data may include network ID data 322, alternate fuel type data 324, location data 326, participant number data 330, cost data 332, interested participant data 334, an express interest button 336 and a become founder button 338. Here, two participants xyz22 and john637 have expressed interest but not taken any further steps. No actual payment has been received. The server operator has provided ID data 322 and estimated cost data 332, based for example on similar locations in the area. A possible lessor has provided actual location data 326. However, the type of fuel, number of participants and total cost have not been decided.

In this embodiment, a potential participant could simply decide these fields as a founder, by pressing button 338. The operator or further be pages could direct the participant to provide payment and take further steps. In fact, the participant could decide to be the sole owner and have data field for participant number 330 to have the value one. More likely, the potential participant will make a partial investment.

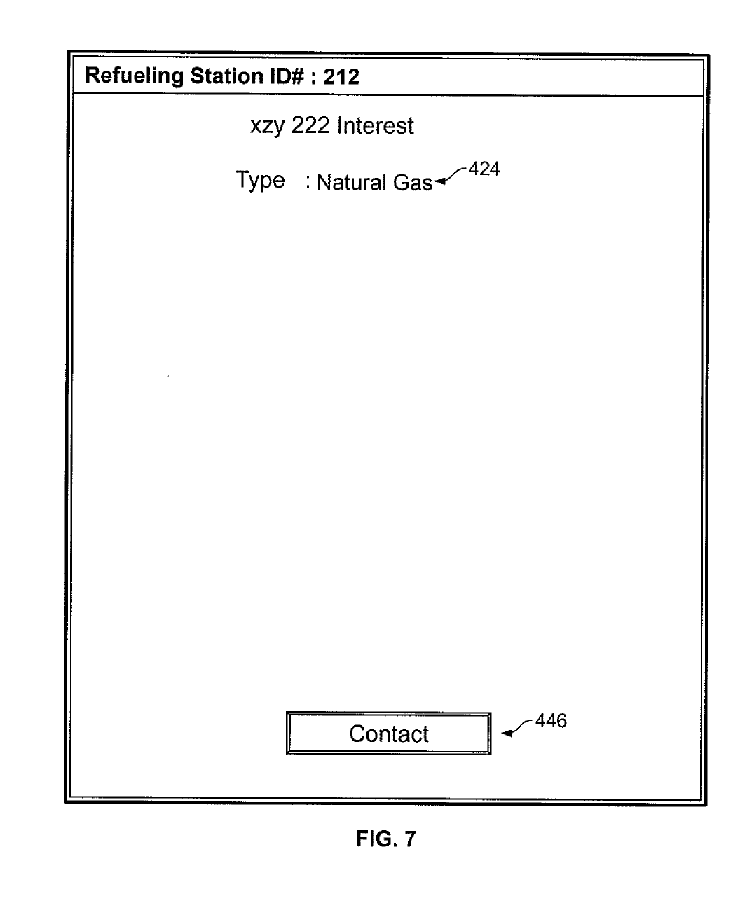

Alternately, the viewer of FIG. 6 could simply express interest via button 336 and be shown FIG. 7. Type interest via input 424 could be provided to enable the operator to collect interest information on possible station 120. Data can be sent via a submission or contact button 446.

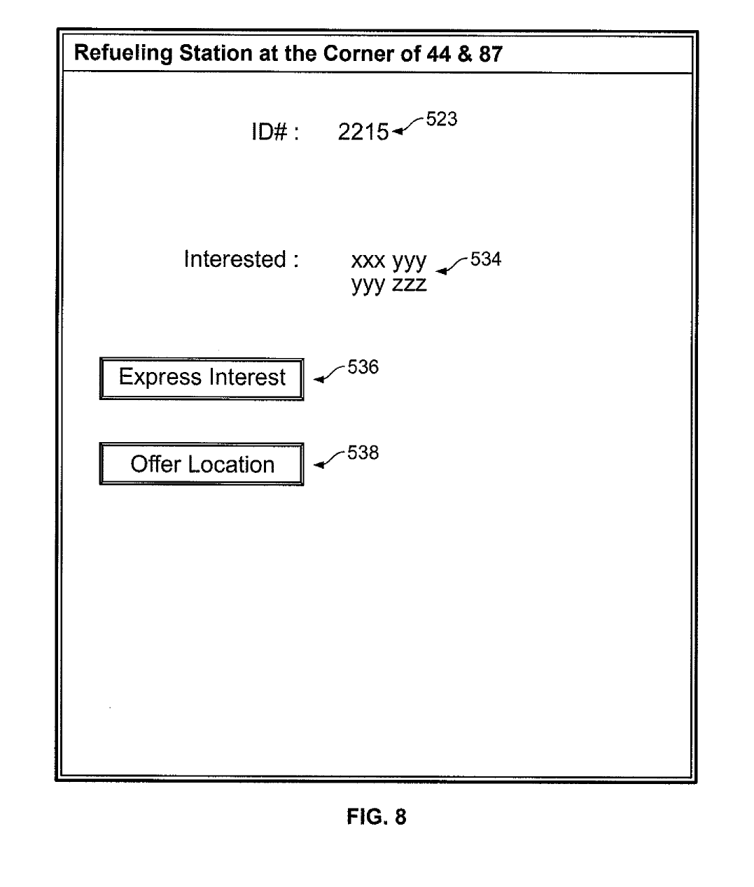

FIG. 8 shows a third GUI of a third remote device with data concerning the possible refueling station 130 of FIG. 2. Here interest in the general area has been expressed by 2 parties, shown in field 534. A first party xxxyyy had expressed interest in the general location, for example via clicking a pointer on map 20, and the website operator provided a graphical indicator with a question mark as possible refueling station 130, and an ID 522. A second party yyyzzz expressed similar interest via a button 536 and provided some data, for example via a web page similar to that shown in FIG. 7.

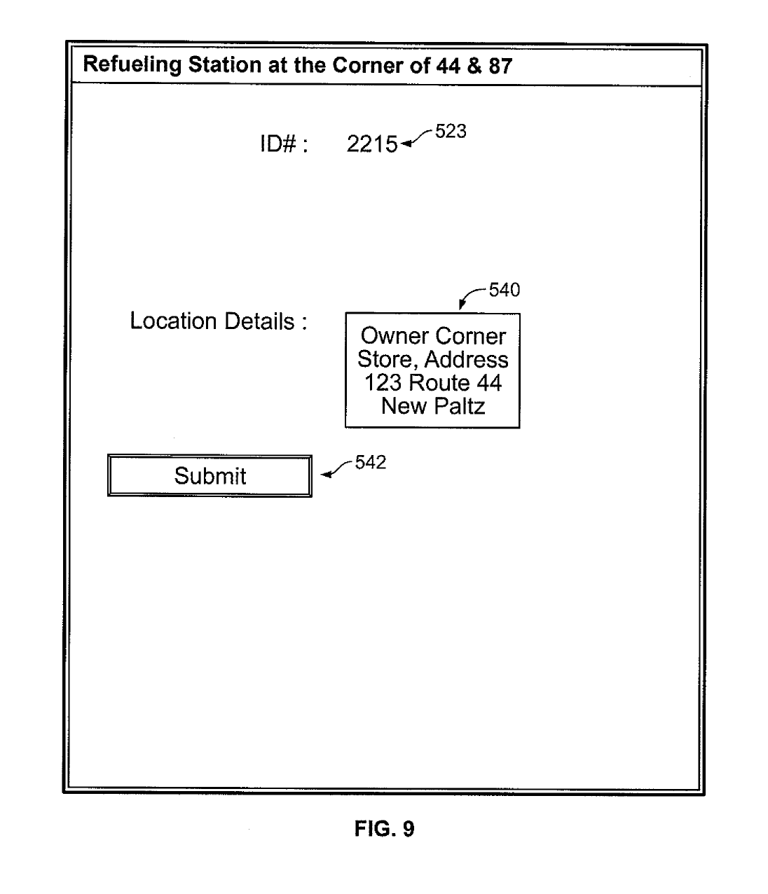

Potential lessors or land providers with a third remote device thus can review map 20, and seeing potential interest, offer a location for the refueling station, for example via button 538, which can result in the web page of FIG. 9. FIG. 9 shows the third GUI of the third remote device with a web page permitting input of data concerning possible participation in creating refueling station 130 of FIG. 2. ID 523 can be provided along with a data entry box 540 for providing actual location data to the server operator via submission button 542.

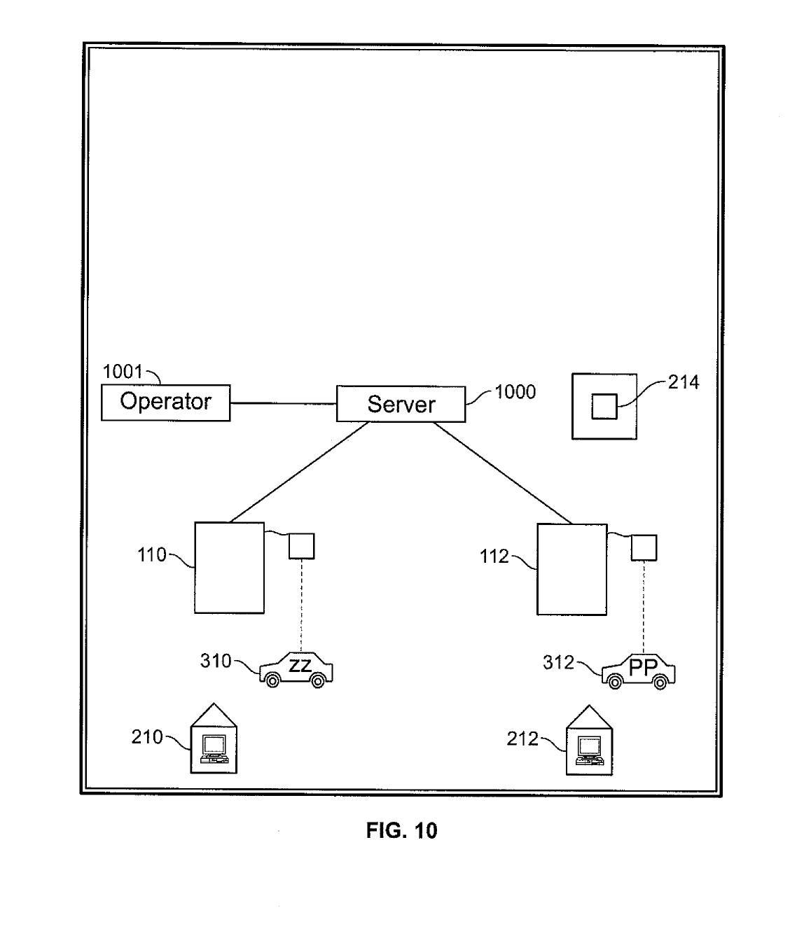

FIG. 10 shows a schematic overview of one embodiment of the system of the present invention. Operator 1001 operates one or more servers 1000 interacting with remote devices 210, 212, 214. Client device 214 may be that of for example a natural gas utility, municipality or gas station owner seeking to provide a location and possible payment for leasing or providing an alternate fuel vehicle refueling location, as described above.

The location may for example be near a natural gas line, although supply of the alternate fuel via vehicles such as trucks or trains is also possible.

Remote devices 210, 212 may be for example home computers of alternate fuel vehicle owners or future owners of alternate fuel vehicles 310, 312, respectively. These remote devices 210, 212 can be used as described above to create actual alternate fuel vehicle refueling stations 110, 112.

What is claimed is:

1. A method for creating an alternate fuel vehicle refueling network comprising:
receiving first location data and first alternate fuel refueling station interest data from a first remote device;
receiving second location data and second alternate fuel refueling station interest data from a second remote device; and
using the first location data, first alternate fuel refueling station interest data, second location data and second alternate fuel refueling station interest data to permit creation of a first alternate fuel refueling station.

2. The method as recited in claim 1 wherein the first alternate fuel refueling station interest data includes payment data.

3. The method as recited in claim 1 further comprising providing alternate fuel refueling station data to the first remote device, the alternate fuel refueling station data including map data, the map data being a function of the first location data.

4. The method as recited in claim 3 wherein the map data includes a plurality of possible alternate fuel refueling station locations.

5. The method as recited in claim 3 wherein the alternate fuel refueling station data includes alternate fuel type data for the first alternate fuel refueling station.

6. The method as recited in claim 3 wherein the alternate fuel refueling station data includes location data for the first alternate fuel refueling station.

7. The method as recited in claim 3 wherein the alternate fuel refueling station data includes price participation data for the first alternate fuel refueling station.

8. The method as recited in claim 3 wherein the alternate fuel refueling station data includes participant number data for the first alternate fuel refueling station.

9. The method as recited in claim 3 wherein the alternate fuel refueling station data includes current participant data for the first alternate fuel refueling station.

10. A method for creating an alternate fuel vehicle refueling network comprising:
receiving first location data from a first remote device;
providing possible location data for a first alternate fuel refueling station as a function of the first location data;
receiving first interest data from the first remote device in the first alternate fuel refueling station; and
providing the first interest data to a second remote device to generate further interest data in the first alternate fuel refueling station.

11. A method for creating an alternate fuel vehicle refueling network comprising:
receiving first location data from a first remote device;
providing alternate fuel refueling station data to the first remote device as a function of the first location data;
in response to the alternate fuel refueling station data, receiving data from the first remote device indicating interest in creating a first alternate fuel refueling station so as to define first interest data;
providing the first interest data to a second remote device; and
in response to the first interest data, receiving second location data including actual location data for a first alternate fuel refueling station.
